(19) United States
(12) Patent Application Publication
(10) Pub. No.: US 2009/0060673 A1
(43) Pub. Date: Mar. 5, 2009

(54) APPARATUS AND METHOD FOR MACHINING

(75) Inventor: James E. Mace, Carmel, IN (US)

Correspondence Address: AKERMAN SENTERFITT, P.O. BOX 3188, WEST PALM BEACH, FL, 33402-3188, US

(73) Assignee: Air Turbine Technology Inc., Boca Raton, FL (US)

(21) Appl. No.: 12/201,711

(22) Filed: Aug. 29, 2008

Related U.S. Application Data
(60) Provisional application No. 60/969,294, filed on Aug. 31, 2007.

(51) Int. Cl. B23Q 11/00; B23C 9/00

(52) U.S. Cl. 409/131; 409/137; 409/234

(57) ABSTRACT

An apparatus and method for machining is provided. A mounting assembly for use with a spindle, a CNC machine, an auto changer device and an air supply line, can include a mounting collar and a mounting block. The mounting collar can have a collar body and a collar arm, where the collar body defines a collar opening and one or more grooves circumscribing the collar opening, where the one or more grooves each have a sealing element positioned therein, and wherein the collar arm has a collar inlet, a collar outlet and a collar channel to provide fluid communication between the collar inlet and the collar outlet. The mounting block can be connected to the CNC machine and can have a block inlet connected to the air supply line, a block outlet, and a block channel to provide fluid communication between the block inlet and the block outlet. The spindle can be selectively positioned through the collar opening and connected to the mounting collar. The collar outlet can be selectively placed in fluid communication with the spindle and sealed by the sealing element. The collar inlet can be selectively placed in fluid communication with the block outlet by the auto changer device. The spindle can be selectively rotated in the collar opening.

### CROSS-REFERENCE TO RELATED APPLICATIONS

This application claims priority to U.S. Provisional Application Ser. No. 60/969,294, filed Aug. 31, 2007, the disclosure of which is hereby incorporated by reference.

### FIELD OF THE INVENTION

This disclosure relates generally to machining processes and more specifically to an apparatus and method for machining.

### BACKGROUND

Computer Numerical Control (CNC) machines are utilized in machining processes, and utilize a computer controller that typically reads G-code instructions for driving a powered mechanical device that is typically used to fabricate metal components by the selective removal of metal. CNC can do numerically directed interpolation of a cutting tool in the work envelope of a machine.

The powered mechanical device is often a pneumatic tool (e.g., a drill) that is fitted for coupling with the CNC machine, such as by insertion into and withdrawal from a CNC machine. The pneumatic tools or spindles can be manually coupled with the CNC machine or an automatic tool changer can be utilized.

Some tools are available from a CNC tool magazine, but require that the machine be stopped after change-over so that suitable power connections can be established with the tool. Other tools are pre-connected to the pneumatic source, but must be manually engaged with the CNC machine. Thus, CNC machines are typically programmed to stop prior to the normal machining cycle to permit manual tool installation or creation of a suitable power link with the tool after coupling with the machine.

Accordingly, there is a need for an apparatus and method for machining that facilitates the tool exchanging process. There is a further need for such an apparatus and method that provides flexibility to use various types of tools.

### SUMMARY

The Summary is provided to comply with 37 C.F.R. §1.73, requiring a summary of the invention briefly indicating the nature and substance of the invention. It is submitted with the understanding that it will not be used to interpret or limit the scope or meaning of the claims.

An apparatus and method for machining is provided. The features of the exemplary embodiments described herein can allow for machining while facilitating the tool exchanging process. These features can also provide flexibility to use various types of tools with the CNC machine or other control device.

In one exemplary embodiment of the present disclosure, a mounting assembly for use with a spindle, a CNC machine, an auto changer device and an air supply line, can include a mounting collar and a mounting block. The mounting collar can have a collar body and a collar arm, where the collar body defines a collar opening and one or more grooves circumscribing the collar opening, where the one or more grooves each have a sealing element positioned therein, and where the collar arm has a collar inlet, a collar outlet and a collar channel to provide fluid communication between the collar inlet and the collar outlet. The mounting block can be connected to the CNC machine and can have a block inlet connected to the air supply line, a block outlet, and a block channel to provide fluid communication between the block inlet and the block outlet, where the spindle is selectively positioned through the collar opening and connected to the mounting collar, where the collar outlet is selectively in fluid communication with the spindle and sealed by the sealing element, where the collar inlet is selectively placed in fluid communication with the block outlet by the auto changer device. The spindle can be selectively rotated in the collar opening.

In another exemplary embodiment, a machining system can have a spindle, a CNC machine, an auto changer device, an air supply line, and a mounting assembly. The mounting assembly can have a mounting collar and a mounting block, where the mounting collar has a collar body and a collar arm, where the collar body defines a collar opening and one or more grooves circumscribing the collar opening, where the one or more grooves each have a sealing element positioned therein, where the collar arm has a collar inlet, a collar outlet and a collar channel to provide fluid communication between the collar inlet and the collar outlet, where the mounting block connects to the CNC machine and has a block inlet connected to the air supply line, a block outlet, and a block channel to provide fluid communication between the block inlet and the block outlet, where the spindle is selectively positioned through the collar opening and connected to the mounting collar, where the collar outlet is selectively in fluid communication with the spindle and sealed by the sealing element, and where the collar inlet is selectively placed in fluid communication with the block outlet by the auto changer device. The spindle can be selectively rotated in the collar opening.

In a further exemplary embodiment, a method can involve mounting a spindle to a CNC machine using the steps of retrieving the spindle from a carousel using an auto changer device, where the spindle has a mounting collar having a collar body and a collar arm, where the collar body defines a collar opening and one or more grooves circumscribing the collar opening, where the one or more grooves each have a sealing element positioned therein, and where the collar arm has a collar inlet, a collar outlet and a collar channel to provide fluid communication between the collar inlet and the collar outlet, wherein the spindle is positioned through the collar opening, wherein the collar outlet is selectively in fluid communication with the spindle and sealed by the sealing element. The method can also include connecting the collar inlet with a block outlet of a mounting block using the auto changer device where the mounting block is connected to the CNC machine and has a block inlet connected to an air supply line and a block channel to provide fluid communication between the block inlet and the block outlet, and selectively rotating the spindle in the collar opening using the air supplied through the collar inlet, the collar outlet and the collar channel.

In yet a further exemplary embodiment, a spindle for use with a CNC machine having an air supply can have a body housing a pneumatically driven turbine, a first coupling arm connected to the body and having a first air supply channel therethrough, and a second coupling arm connected to the body and having a second air supply channel therethrough. The first and second coupling arms can be orthogonal to each other and individually selectively connectable to the CNC machine. The first air supply channel can place the turbine in fluid communication with the air supply when the first coupling arm is connected to the CNC machine. The second air supply channel can place the turbine in fluid communication with the air supply when the second coupling arm is connected to the CNC machine.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is perspective view of an exemplary machining system according to an embodiment of the present invention;

FIG. 2 is a perspective view of a portion of the system of FIG. 1;

FIG. 3 is a perspective view of another portion of the system of FIG. 1;

FIG. 4 is a perspective view of another portion of the system of FIG. 1;

FIG. 5 is a perspective view of a spindle and mounting collar of the system of FIG. 1;

FIG. 6 is a perspective view of the mounting collar of FIG. 5;

FIG. 7 is another perspective view of the mounting collar of FIG. 5;

FIG. 8 is a plan and cross-sectional view of the mounting collar of FIG. 5;

FIG. 9 is a plan and cross-sectional view of another embodiment of a mounting collar that can be used with the system of FIG. 1;

FIG. 10 is a plan and cross-sectional view of another embodiment of a mounting collar that can be used with the system of FIG. 1;

FIG. 11 is a plan, side, and bottom view of the mounting block of the system of FIG. 1;

FIG. 12 is a perspective view of a portion of the spindle of FIG. 5;

FIG. 13 is a plan view of the spindle of FIG. 5;

FIG. 13a is a schematic representation of the mounting collar connected with the mounting block;

FIG. 13b is a schematic representation of the mounting collar and mounting block operably coupled to the spindle;

FIG. 14 is a perspective view of a portion of the system of FIG. 1 with the auto tool changer;

FIG. 15 is another perspective view of the portion of the system of FIG. 1 with the auto tool changer;

FIG. 16 is another perspective view of the portion of the system of FIG. 1 with the auto tool changer;

FIG. 17 is a perspective view of the carousel of the system of FIG. 1;

FIG. 18 is a perspective view of the mounting block coupled to the CNC machine of FIG. 1;

FIG. 19 is an exploded view of the mounting block of FIG. 18;

FIG. 20 is a perspective view of a portion of the mounting block of FIG. 19;

FIG. 21 is a perspective view of the mounting block of FIG. 18;

FIG. 22 is a plan view of another exemplary embodiment of a spindle connected with the mounting block;

FIG. 23 is a plan view of an exemplary spindle according to an embodiment of the present invention; and

FIG. 24 is a plan view of an exemplary spindle according to another embodiment of the present invention.

### DETAILED DESCRIPTION OF THE INVENTION

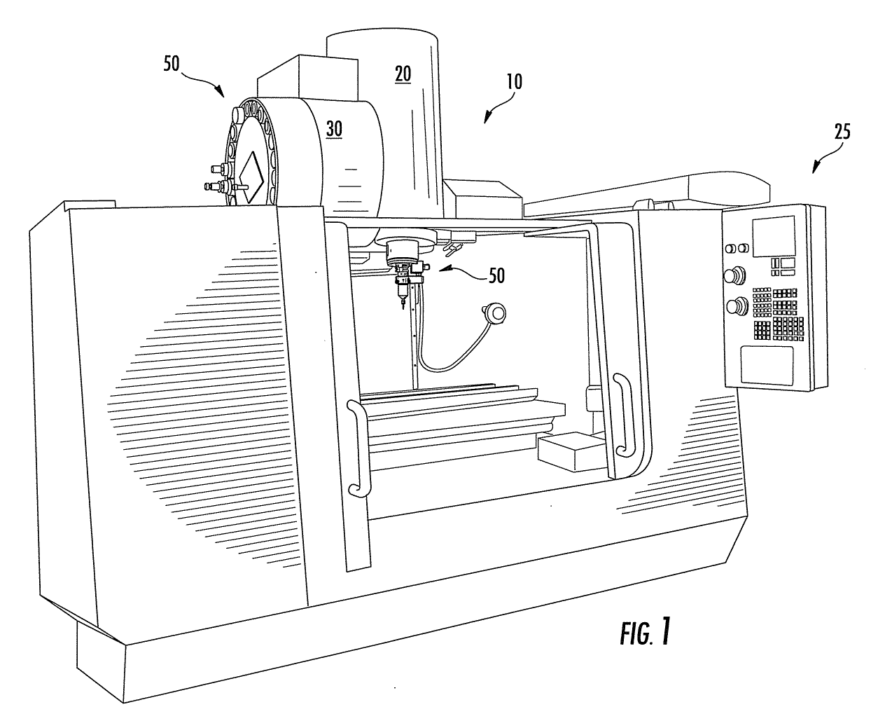

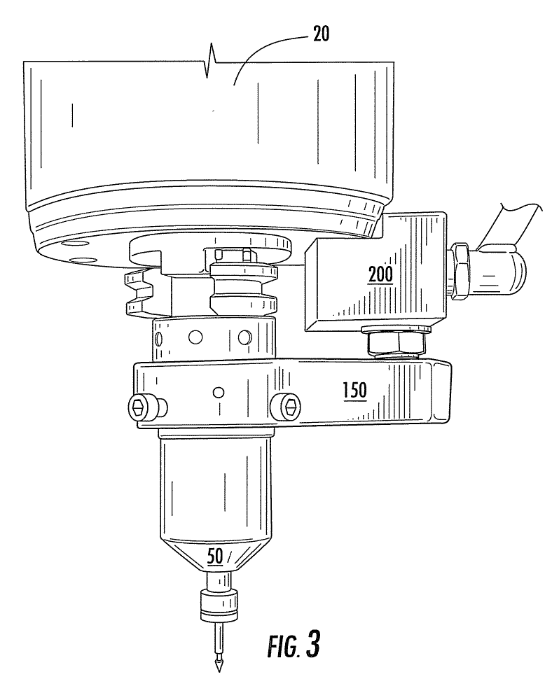

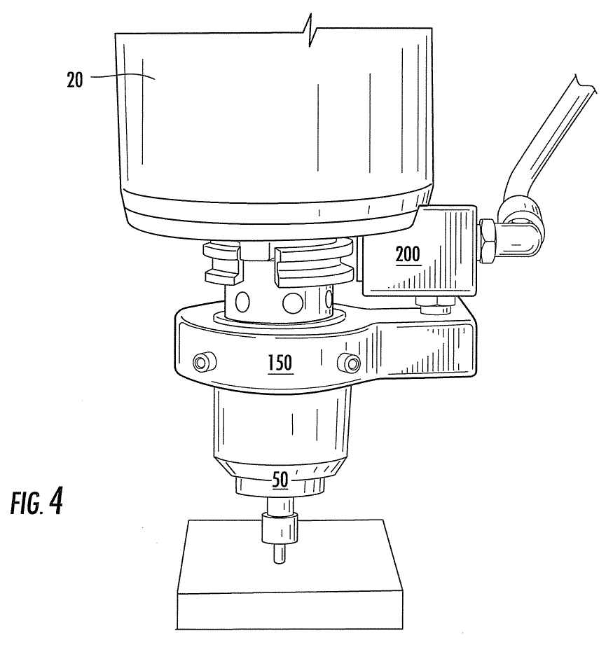

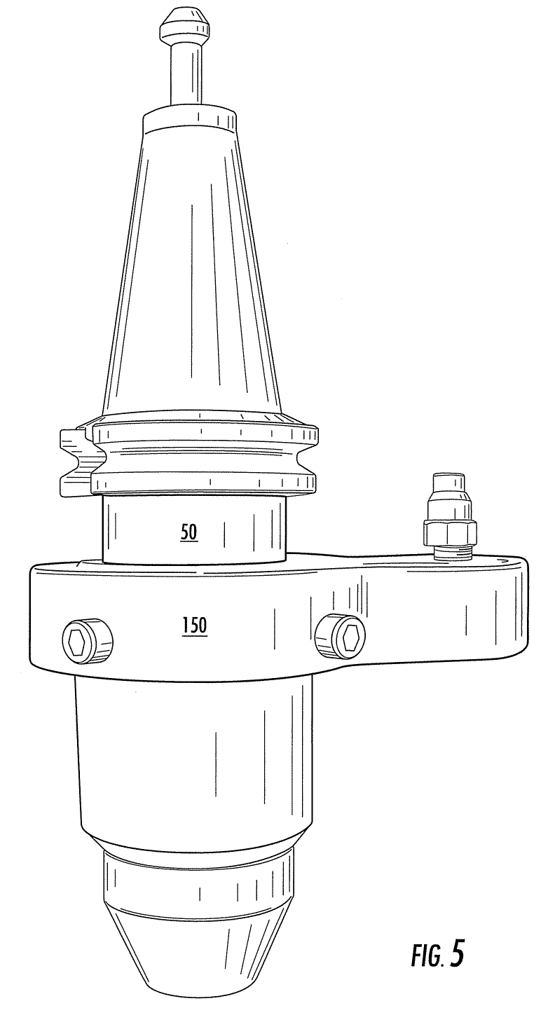

Referring to the drawings, and in particular to FIGS. 1-5, a machining system is shown and generally represented by reference numeral 10. System 10 can include a control device 20, such as a CNC machine, a tool carousel 30, and one or more tools or spindles 50. The control device 20 can include a user input device 25 for inputting commands. The control device 20 can utilize various software to implement a machining process on a work piece, and the present disclosure is not intended to be limited based upon the type of control utilized.

The system 10 can also have a universal spindle mounting assembly (USMA) 100 that cooperates with the spindles 50 to allow for automatic exchanging of the spindles with the CNC machine 20. In the exemplary embodiment of system 10, the spindles 50 are exchanged between the CNC machine 20 and the cylindrical carousel 30 by way of an auto changer device 300, which will be explained later in greater detail. However, the present disclosure contemplates the use of other structures and techniques for connecting and disconnecting the spindles 50 with the CNC machine 20 through use of the USMA 100, such as a linear carousel.

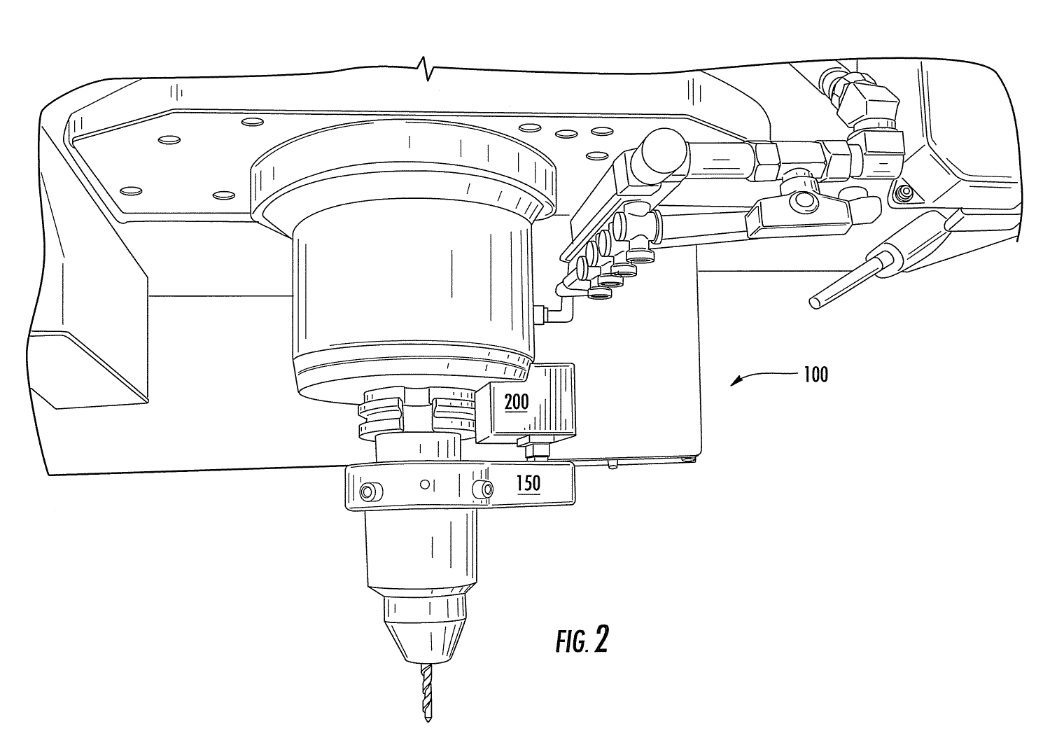

The USMA 100 can include a mounting collar 150 and a mounting block 200, as shown more clearly in FIGS. 2-4. The mounting collar 150 can be operably coupled to the spindle 50, while the mounting block 200 can be operably coupled to the CNC machine 20.

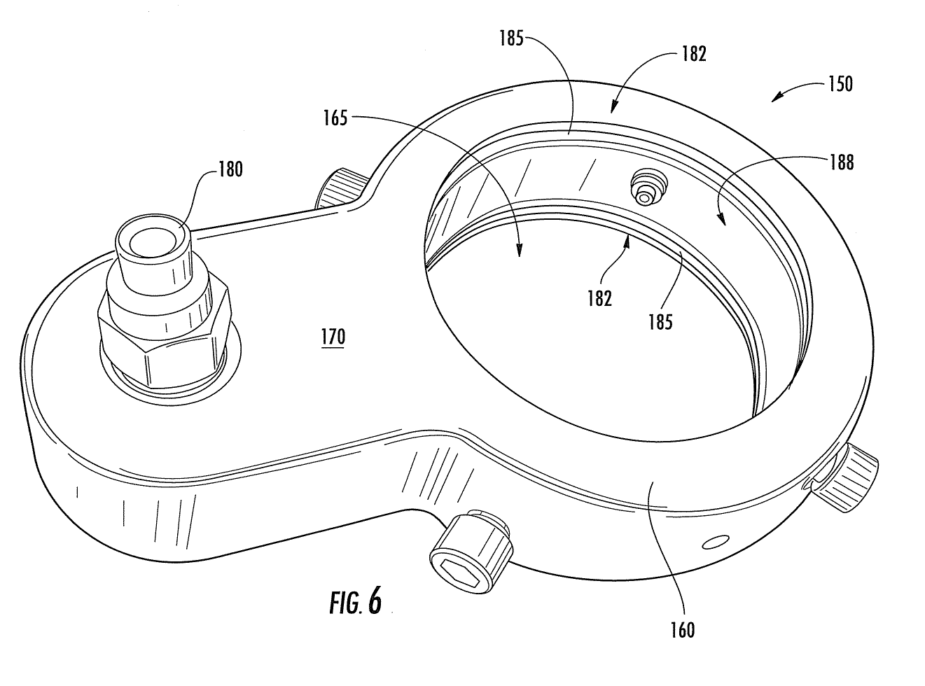

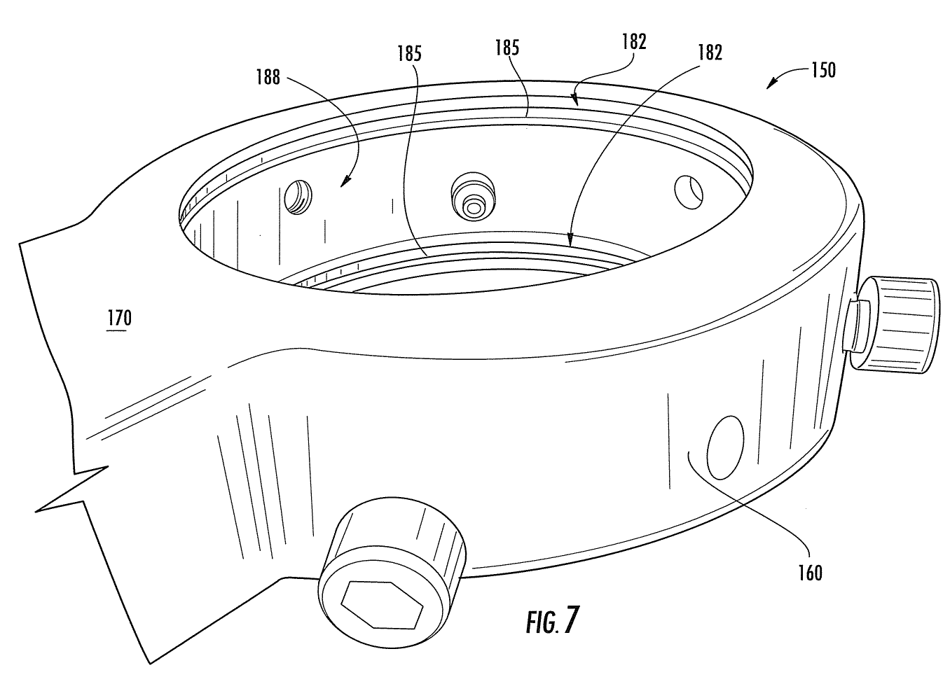

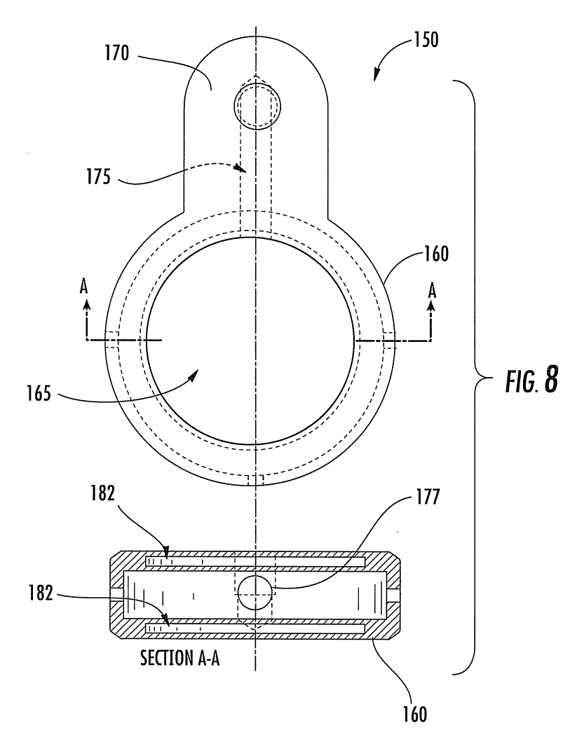

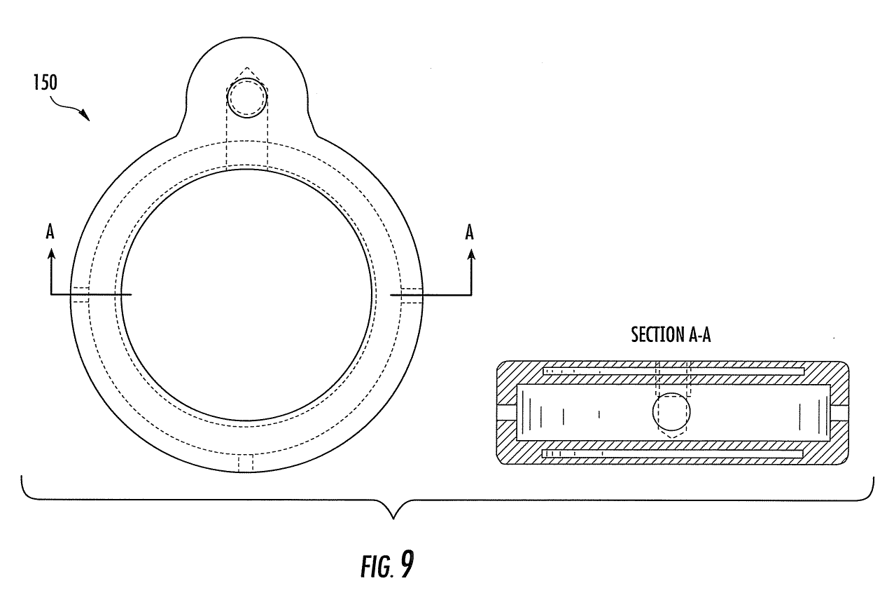

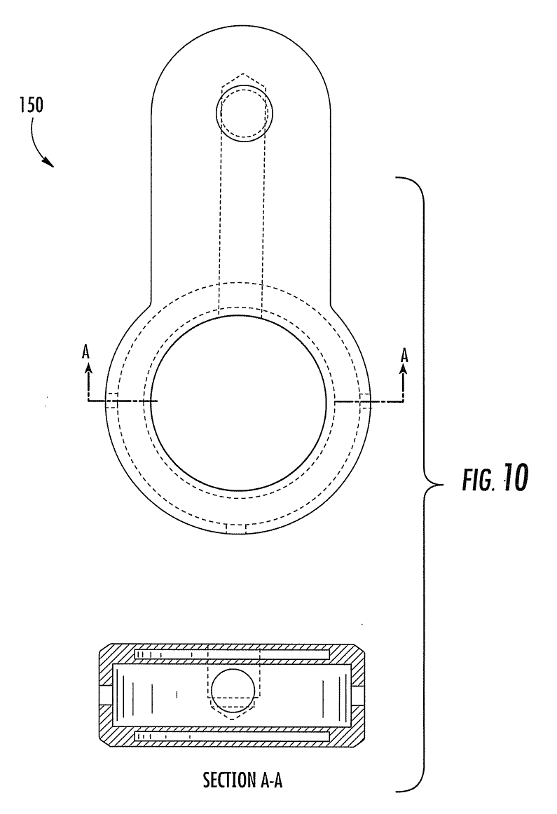

Referring additionally to FIGS. 6-8, the mounting collar 150 can have a generally circular shaped body 160 defining a mounting or collar opening 165 therethrough. The mounting collar 150 can have a collar arm 170 extending from the circular body 160. The collar arm 170 can have an arm supply channel 175, an arm supply opening 177, and a quick connect device 180 in communication with each other in order to deliver air from the quick connect device to the mounting opening 165. The mounting opening 165 can be defined in part (e.g., circumscribed) by a pair of grooves 182 in the collar body 160 that have O-rings 185 or other sealing structure positioned therein. The grooves 182 and O-rings 185 can define a collar supply channel 188 therebetween. Various materials can be used for the O-ring 185, including rubber. Other shapes and sizes for the mounting collar 150 can also be used, such as shown in FIGS. 9 and 10.

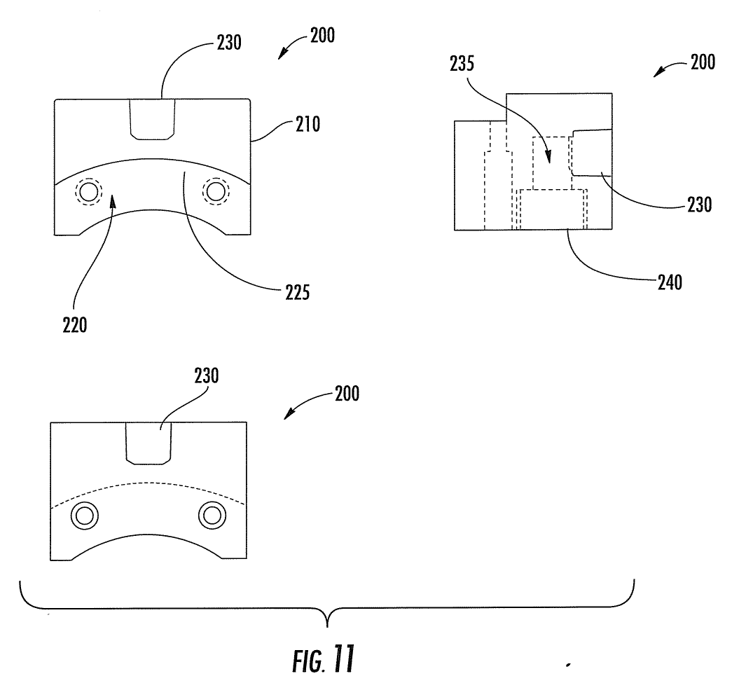

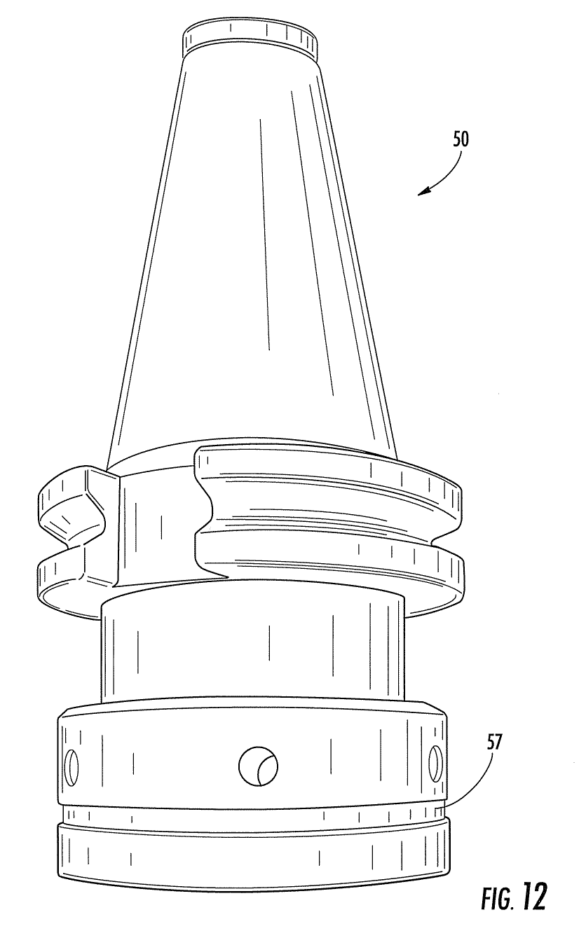

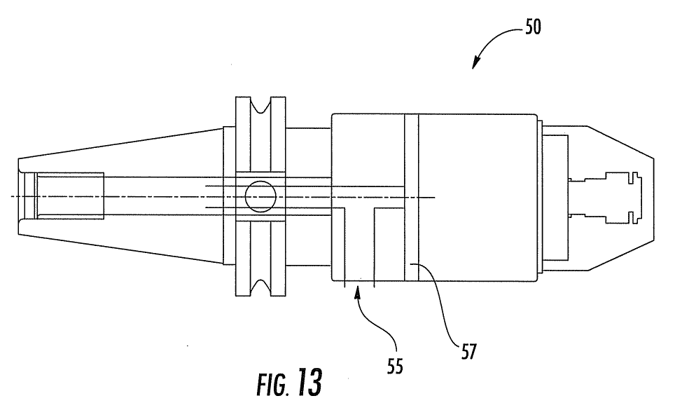

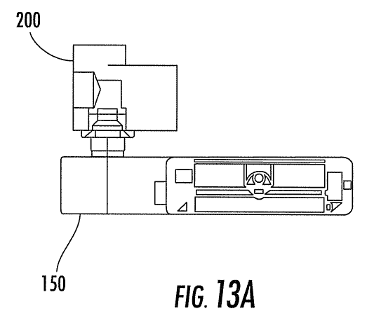

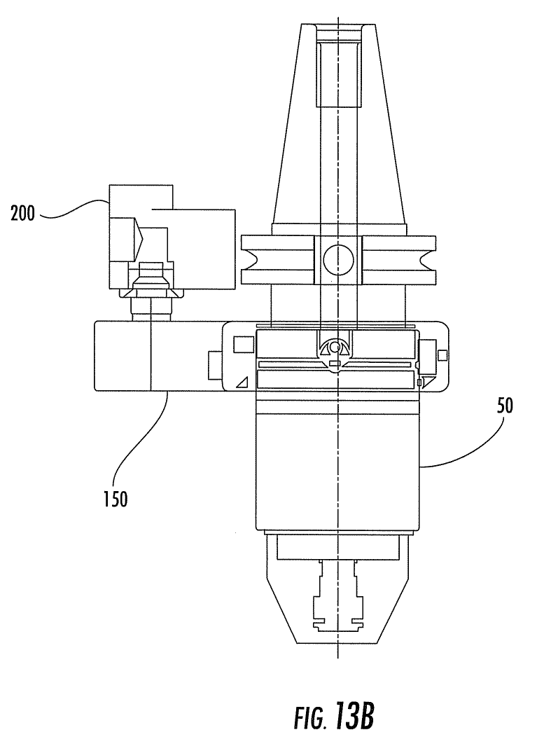

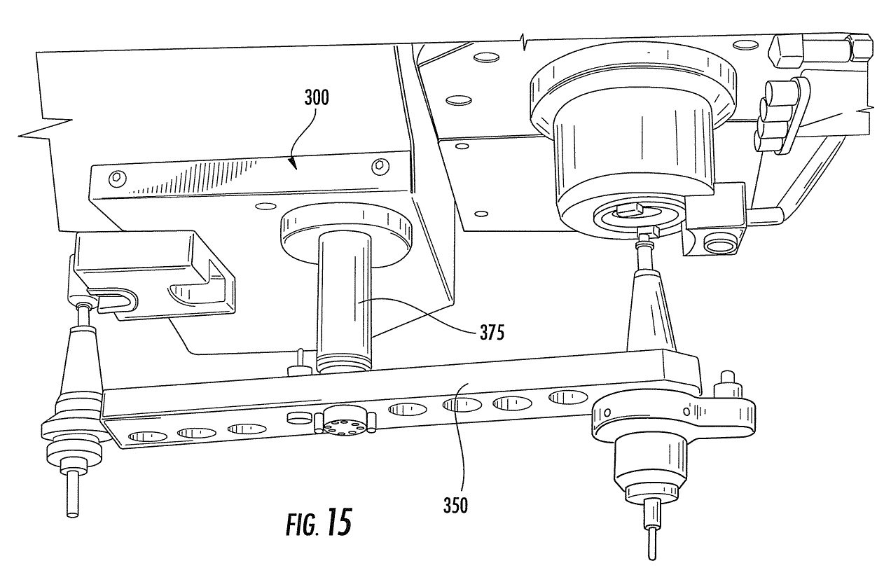

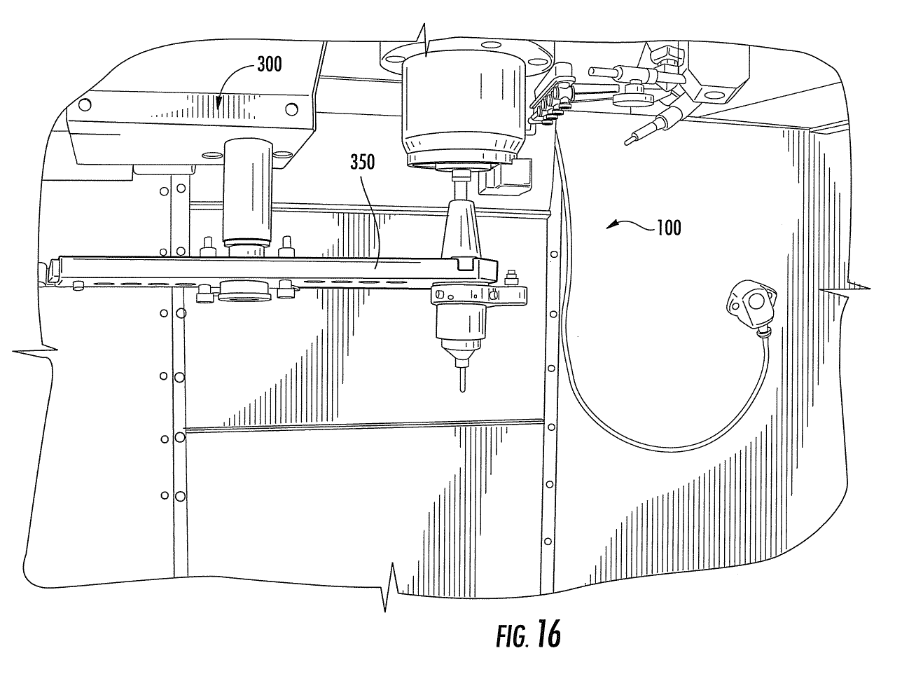

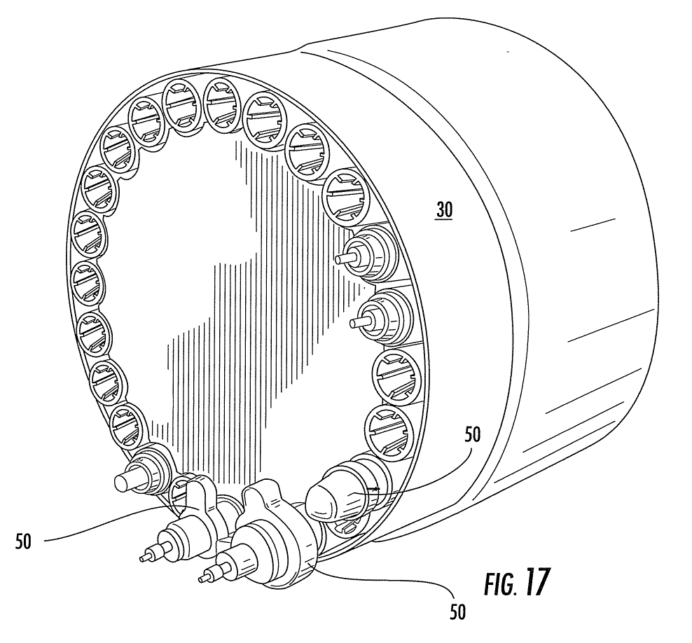

Referring additionally to FIGS. 11-17, the mounting collar 150 can be selectively coupled to the mounting block 200 by the auto change device 300, where the mounting block and mounting collar are in fluid communication in order to deliver air to the mounting opening 165. The spindle 50 can be rotated by way of the air delivered through the collar arm 170, such as rotation by 45 degrees, although other degrees of rotation are contemplated. The spindle 50 can also be powered by the air delivered through the collar arm 170, the mounting opening 165 and the collar supply channel 188 into the spindle air inlet 55 (FIG. 13). A spindle groove 57 can be provided on the spindle housing to act as a guide for the rotation of the spindle 50.

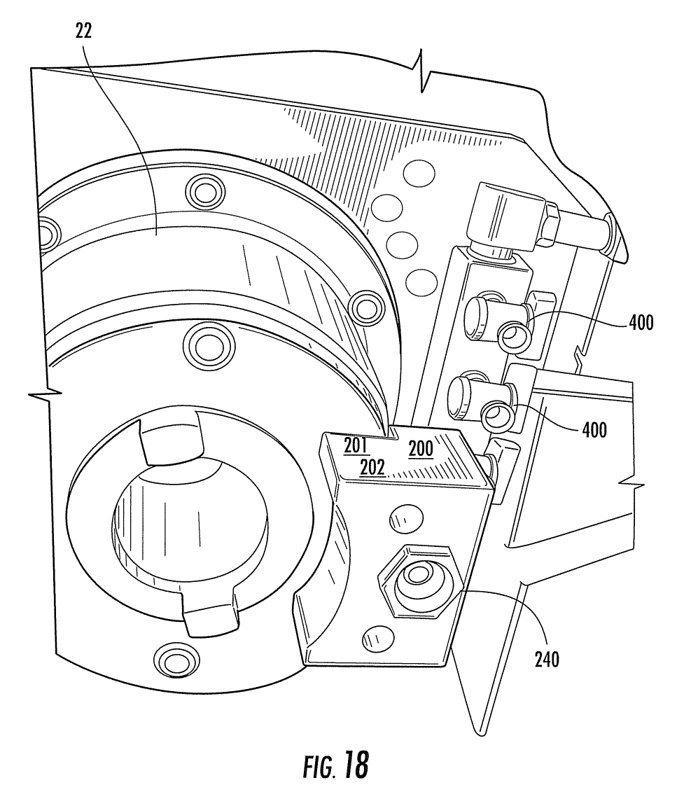

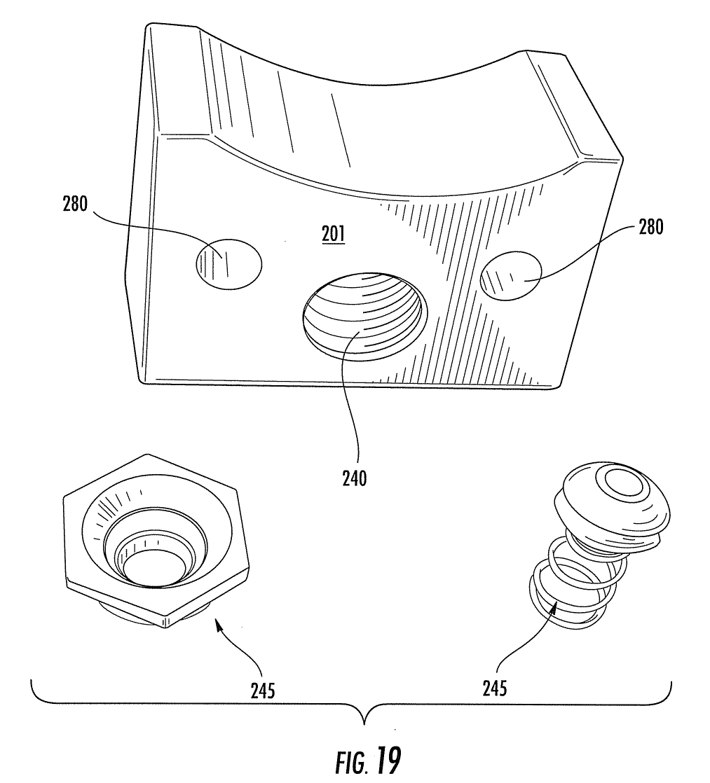

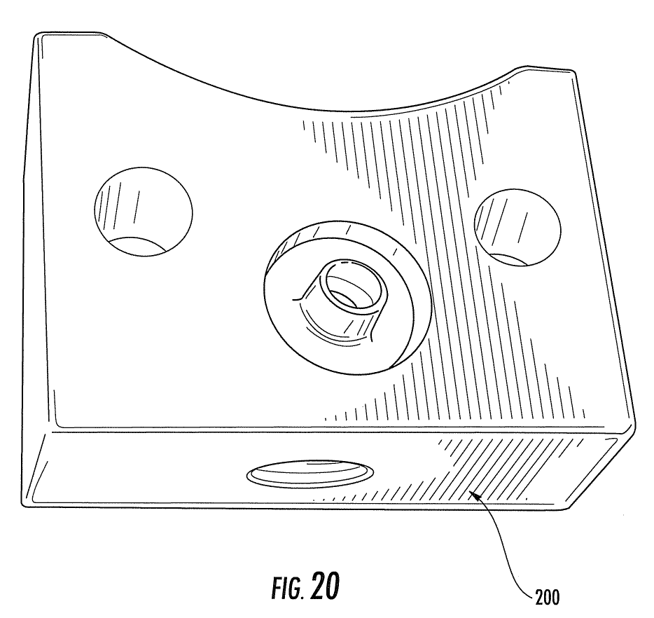

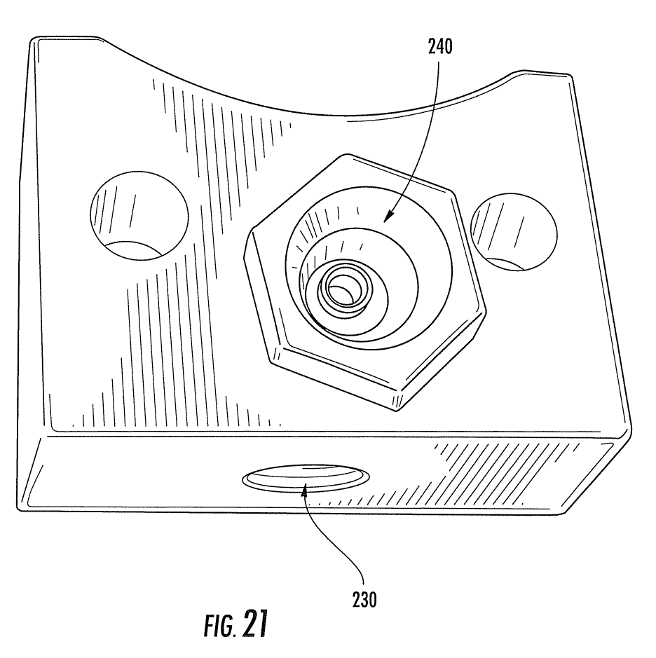

Referring additionally to FIGS. 18-21, the mounting block 200 can have a mounting body 210 with a coupling recess 220 formed therein. In the exemplary embodiment, the recess 220 is defined in part by a circular sidewall 225 that can abut or otherwise be positioned in proximity to a circular wall 22 of the CNC machine 20. However, other shapes and sizes can be used for the recess 220, such as a planar shape where the sidewall of the CNC machine is flat. The use of the recess 220 allows a portion of the body 210 to extend beyond (above in the present disclosure) the sidewall 22 of the CNC machine 20 to facilitate coupling the mounting block 200 with the air supply lines 400, as will be discussed later in greater detail. The mounting body 210 can be separated and assembled into a number of portions, such as to facilitate manufacture, including first and second portions 201 and 202, although any number of portions, as well as a single body is contemplated by the present disclosure.

The mounting block 200 can have an air inlet 230, a block supply channel 235, and an air outlet 240. The air inlet 230 can be threaded or otherwise have a fastening mechanism so that a quick connect coupler can be connected thereto in order to place the air inlet in fluid communication with one of the supply channels 400. The air outlet 240 can include a quick connect coupling assembly 245, such as a female connector that corresponds with a male connector being used for quick connect device 180. One or more fastening devices (not shown) can be used to connect the mounting block 200 to the CNC machine 20, such as by positioning screws through holes 280 formed through the body 210 of the mounting block. The present disclosure contemplates the use of other fastening structures and techniques being utilized to connect the mounting block 200 to the CNC machine 20, including quick connect structures, such as a bayonet connection.

In one embodiment, the mounting block 200 can have an adjustable connection structure so that the mounting block can be connected to CNC machines of different sizes. For example, a sliding connector can be used so that the fastening mechanisms (e.g., bolts) can be selectively positioned through corresponding fastening mechanisms (threaded openings) formed in the CNC machine. The use of the curved sidewall 225 of recess 220 allows the mounting block 200 to be positioned in proximity to various sized CNC machines that have curved sidewalls.

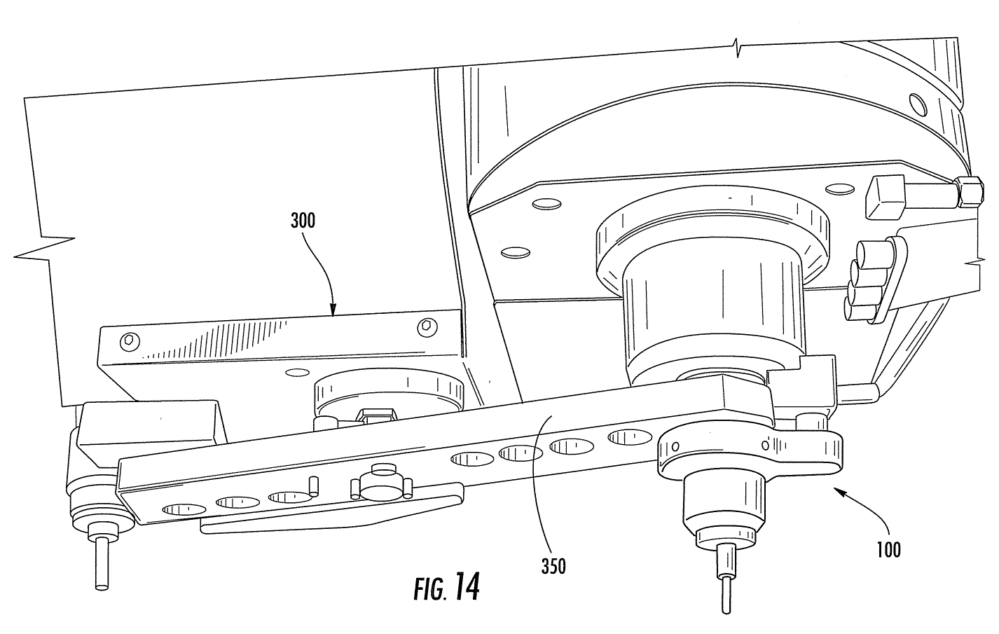

In operation, the auto changer arm 350 of auto changer device 300 can selectively engage with one of the spindles 50 that are held in the carousel 30. The spindles 50 can each have a mounting collar 150 connected thereto. The auto changer device 300 can move the spindle 50 from its position in the carousel 30 to a position near the CNC machine 20 through use of the auto changer piston 375 (see FIGS. 14-16). The mounting collar 150 can be coupled to and placed in fluid communication with the mounting block 200 through use of the quick connect device 180 and the quick connect assembly 245 by the auto changer device 300. The USMA 100 can provide for rotation of the spindle 50 (e.g., by 45 degrees) to allow for connection with the CNC machine 20 and/or loading back into the carousel 30.

The USMA 100 allows for the use of various types of spindles 50 with the CNC machine 20 and the auto changer device 300. For example, the mounting collar 100 can be coupled with spindles that are not specifically designed for use with the auto changer device 300. The air supply to the spindle 50 does not need to be though the plunger teat but rather can be done through use of collar arm 170.

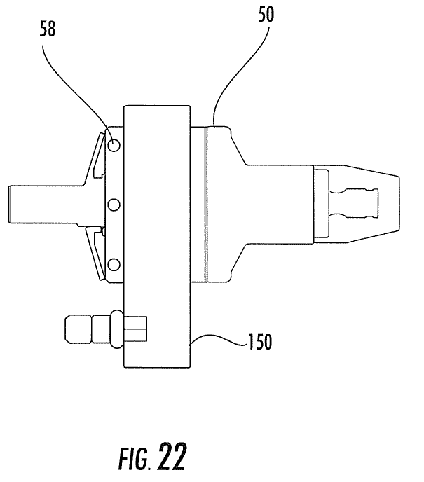

In another embodiment shown in FIG. 22, the spindle 50 can have one or more exhaust holes 58. The mounting collar 150 is positioned with respect to the spindle 50 so as not to obstruct the exhaust holes 58.

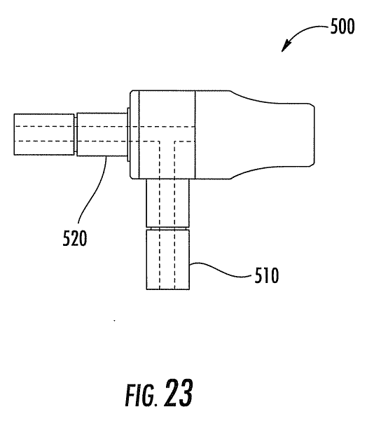

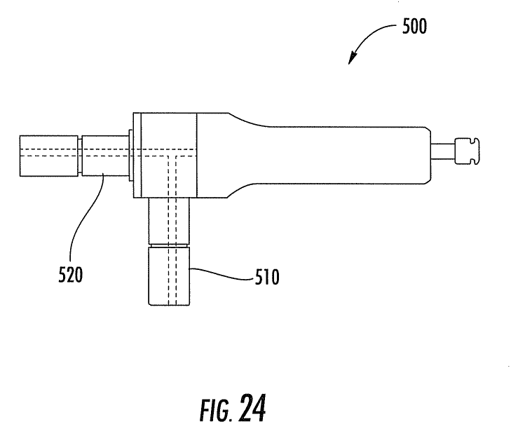

In yet other embodiments, shown in FIGS. 23 and 24, a spindle 500 can be provided with a plurality of coupling arms 510 and 520, such as perpendicular to each other. The coupling arms 510 and 520 can have air inlets, as well as appropriate valving, provided therethrough for powering the spindles 500. The coupling arms 510 and 520 allow for a connection with the CNC machine.

In one embodiment, the coupling arm 520 is positioned along a top of the spindle 500 so that the CNC machine can be connected therewith to orientate the spindle in a vertical direction, while the coupling arm 510 is positioned along a side of the spindle 500 so that the CNC machine can be connected therewith to orientate the spindle in a horizontal direction. The multiple orientations of the spindle 500 provide for flexibility in machining a work piece, such as from above or from the side. The present disclosure also contemplates positioning the coupling arms 510 and 520 at different areas and/or different angles with respect to the spindle 500.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed as the best mode contemplated for carrying out this invention, but that the invention will include all embodiments falling within the scope of the appended claims.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims.

What is claimed is:

1. A mounting assembly for use with a spindle, a CNC machine, an auto changer device and an air supply line, the assembly comprising:
a mounting collar having a collar body and a collar arm, wherein the collar body defines a collar opening and one or more grooves circumscribing the collar opening, wherein the one or more grooves each have a sealing element positioned therein, and wherein the collar arm has a collar inlet, a collar outlet and a collar channel to provide fluid communication between the collar inlet and the collar outlet; and
a mounting block connected to the CNC machine and having a block inlet connected to the air supply line, a block outlet, and a block channel to provide fluid communication between the block inlet and the block outlet, wherein the spindle is selectively positioned through the collar opening and connected to the mounting collar, wherein the collar outlet is selectively in fluid communication with the spindle and sealed by the sealing element, wherein the collar inlet is selectively placed in fluid communication with the block outlet by the auto changer device, and wherein the spindle selectively rotates in the collar opening.

2. The assembly of claim 1, wherein the mounting block has an adjustable fastening mechanism that selectively connects with the CNC machine.

3. The assembly of claim 1, wherein the sealing element is an O-ring.

4. The assembly of claim 1, wherein the one or more groves is two grooves defining a channel therebetween, and wherein the channel circumscribes the collar opening.

5. The assembly of claim 1, wherein the collar inlet has a quick connect device that corresponds with a quick connect device of the block outlet.

6. The assembly of claim 1, wherein the block inlet has a quick connect device that corresponds with a quick connect device of the air supply line.

7. A machining system comprising:
a spindle;
a CNC machine;
an auto changer device;
an air supply line; and
a mounting assembly having a mounting collar and a mounting block, wherein the mounting collar has a collar body and a collar arm, wherein the collar body defines a collar opening and one or more grooves circumscribing the collar opening, wherein the one or more grooves each have a sealing element positioned therein, wherein the collar arm has a collar inlet, a collar outlet and a collar channel to provide fluid communication between the collar inlet and the collar outlet, wherein the mounting block connects to the CNC machine and has a block inlet connected to the air supply line, a block outlet, and a block channel to provide fluid communication between the block inlet and the block outlet, wherein the spindle is selectively positioned through the collar opening and connected to the mounting collar, wherein the collar outlet is selectively in fluid communication with the spindle and sealed by the sealing element, wherein the collar inlet is selectively placed in fluid communication with the block outlet by the auto changer device, and wherein the spindle selectively rotates in the collar opening.

8. The system of claim 7, wherein the mounting block has an adjustable fastening mechanism that selectively connects with the CNC machine.

9. The system of claim 7, wherein the sealing element is an O-ring.

10. The system of claim 7, wherein the one or more groves is two grooves defining a channel therebetween, and wherein the channel circumscribes the collar opening.

11. The system of claim 7, wherein the collar inlet has a quick connect device that corresponds with a quick connect device of the block outlet.

12. The system of claim 7, wherein the block inlet has a quick connect device that corresponds with a quick connect device of the air supply line.

13. A method of mounting a spindle to a CNC machine, the method comprising:
retrieving the spindle from a carousel using an auto changer device, wherein the spindle has a mounting collar having a collar body and a collar arm, wherein the collar body defines a collar opening and one or more grooves circumscribing the collar opening, wherein the one or more grooves each have a sealing element positioned therein, and wherein the collar arm has a collar inlet, a collar outlet and a collar channel to provide fluid communication between the collar inlet and the collar outlet, wherein the spindle is positioned through the collar opening, wherein the collar outlet is selectively in fluid communication with the spindle and sealed by the sealing element;
connecting the collar inlet with a block outlet of a mounting block using the auto changer device, wherein the mounting block is connected to the CNC machine and has a block inlet connected to an air supply line and a block channel to provide fluid communication between the block inlet and the block outlet; and
selectively rotating the spindle in the collar opening using the air supplied through the collar inlet, the collar outlet and the collar channel.

14. The method of claim 13, further comprising sealing the collar outlet with the spindle using an O-ring.

15. The method of claim 13, further comprising providing a quick connect device for connecting the collar inlet with the block outlet.

16. The method of claim 13, further comprising providing a quick connect device for connecting the air supply line with the block inlet.

17. The method of claim 13, further comprising adjustably fastening the mounting block to the CNC machine.

18. The method of claim 13, wherein the one or more groves is two grooves defining a channel therebetween, and wherein the channel circumscribes the collar opening.

19. The method of claim 13, further comprising guiding rotation of the spindle using a spindle groove.

20. A spindle for use with a CNC machine having an air supply, the spindle comprising:
a body housing a pneumatically driven turbine;
a first coupling arm connected to the body and having a first air supply channel therethrough; and
a second coupling arm connected to the body and having a second air supply channel therethrough, wherein the first and second coupling arms are orthogonal to each other and are individually selectively connectable to the CNC machine, wherein the first air supply channel places the turbine in fluid communication with the air supply when the first coupling arm is connected to the CNC machine, and wherein the second air supply channel places the turbine in fluid communication with the air supply when the second coupling arm is connected to the CNC machine.
